(19) United States
(12) Patent Application Publication
(10) Pub. No.: US 2026/0098113 A1
(43) Pub. Date: Apr. 9, 2026

(54) MICROBE RESISTANT STYRENIC LATEX COMPOSITION

(71) Applicant: Rohm and Haas Company, Collegeville, PA (US)

(72) Inventors: Arnold S. Brownell, Lansdale, PA (US); Tara L. Conley, Chalfont, PA (US); Erica A. Frankel, Audubon, PA (US); Benjamin Reiner, Collegeville, PA (US)

(21) Appl. No.: 19/111,377

(22) PCT Filed: Sep. 15, 2023
(86) PCT No.: PCT/US2023/074320

§ 371 Date: Mar. 13, 2025

Related U.S. Application Data
(60) Provisional application No. 63/408,327, filed on Sep. 20, 2022.

(51) Int. Cl. C08F 212/08; C08F 2/22; C08K 5/14; C08K 5/42

(52) U.S. Cl. CPC C08F 212/08; C08F 2/22; C08K 5/14; C08K 5/42

(57) ABSTRACT

The present invention relates to a composition comprising a) an aqueous dispersion of styrenic copolymer particles having a z-average particle size in the range of from 50 to 500 nm; and b) a C₄-C₁₀-alkyl hydroperoxide having a concentration in the range of from 250 ppm to 5000 ppm, based on the weight of the composition. The composition of the present invention provides a latex that is resistant to microbial growth even in the absence of a biocide.

### BACKGROUND OF THE INVENTION

The present invention relates to a styrenic latex composition that is resistant to microbial growth even in the absence of a biocide.

Aqueous dispersions of polymer particles (i.e., latexes) used in the coatings industry are preserved with antimicrobial agents to inhibit the formation and growth of biological organisms such as bacteria, yeast, and mold while in storage. Inhibition of these organisms prevents product degradation and spoilage, as well as off-gassing of volatile products and consequent pressure build-up in closed containment. Preservation is therefore essential for reasons of health, safety, and performance.

In-can preservatives such as isothiazolinones are facing intense regulatory scrutiny for their real or perceived adverse impact on health, safety, and the environment; in fact, an outright ban of these biocides in many parts of the world appears in the offing. Inasmuch as the development of new biocides is unlikely for reasons of cost and a widespread perception, justified or not, of their inherent dangers, a need exists to supplant biocides with alternative non-biocidal preservatives that are safer and more sustainable.

A recent example of a non-biocidal approach for preserving paints against microbial contamination can be found in EP 3 456 787 B1, which discloses a water-borne coating formulation adjusted to a pH in the range of 10 to 12.5. While ostensibly effective, these very high pH formulations create additional safety and health concerns that render this approach impractical. Other non-traditional approaches such as the addition of silver or zinc ions may adversely affect the properties of the paint and face regulatory scrutiny as well. For these reasons, other safer and more sustainable approaches for preserving paints, and materials that are used in paints, are needed.

### SUMMARY OF THE INVENTION

The present invention addresses a need in the art by providing, in one aspect, a composition comprising a) an aqueous dispersion of styrenic copolymer particles having a z-average particle size in the range of from 50 to 500 nm; and b) a C₄-C₁₀-alkyl hydroperoxide having a concentration in the range of from 250 ppm to 5000 ppm, based on the weight of the composition.

The composition of the present invention provides a latex that is resistant to microbial growth even in the absence of a biocide.

### DETAILED DESCRIPTION OF THE INVENTION

In a first aspect, the present invention is a composition comprising a) an aqueous dispersion of styrenic copolymer particles having a z-average particle size in the range of from 50 to 500 nm; and b) a C₄-C₁₀-alkyl hydroperoxide having a concentration in the range of from 250 ppm to 5000 ppm, based on the weight of the composition.

In a first step of the preparation of the composition of the present invention styrene is advantageously contacted with an ethylenically unsaturated monomer under emulsion polymerization conditions to form an aqueous dispersion of polymer particles. Examples of suitable ethylenically unsaturated monomers include acrylates such ethyl acrylate, n-butyl acrylate, t-butyl acrylate, 2-ethylhexyl acrylate, 2-propylheptyl acrylate, and ureido acrylate; methacrylates, such as methyl methacrylate, ethyl methacrylate, n-butyl methacrylate, t-butyl methacrylate, isobutyl methacrylate, isobornyl methacrylate, lauryl methacrylate, and cyclohexyl methacrylate; acid monomers including carboxylic acid monomers and salts thereof, such as acrylic acid, methacrylic acid, and itaconic acid, and salts thereof; phosphorus acid monomers such and salts thereof such as phosphoethyl methacrylate and salts thereof; and sulfonic acid monomers and salts thereof such as 2-acrylamido-2-methyl-1-propanesulfonic acid, salts of 2-acrylamido-2-methyl-1-propanesulfonic acid, vinyl sulfonic acid, salts of vinyl sulfonic acid, sodium 4-vinylbenzene sulfonate, 2-propene-1-sulfonic acid and salts of 2-propene-1-sulfonic acid, as well as combinations thereof and salts thereof. Sodium 4-vinylbenzene sulfonate (also known as sodium styrene sulfonate or SSS) is a preferred ethylenically unsaturated sulfonate. One or more acid monomers preferably comprise from 0.1 to 10 weight percent of the ethylenically unsaturated monomers used to prepare the polymer particles.

Other examples of ethylenically unsaturated monomers include acrylamide or C₁-C₆-alkyl acrylamides, acrylonitrile, vinyl monomers such as vinyl trimethoxysilane; as well as multiethylenically unsaturated monomers such as divinyl benzene and allyl methacrylate.

As used herein, the term “styrenic copolymer particles” refer to copolymer particles that comprise from 10 to 90 weight percent structural units of styrene and 10 to 90 weight percent structural units of one or more ethylenically unsaturated monomers. Accordingly, the term “an ethylenically unsaturated monomer” refers to one or more ethylenically unsaturated monomer.

As used herein, the term “structural units” refers to the remnant of the recited monomer after polymerization. For example, a structural unit of styrene is illustrated as follows:

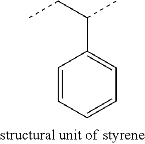

where the dotted lines represent the points of attachment to the polymer backbone.

Examples of preferred ethylenically unsaturated monomers are acrylate monomers. Preferably, the weight-to-weight ratio of styrene to acrylate monomer is in the range of from 60:40 or from 50:50 or from 45:55, to 20:80 or to 30:70 or to 35:65. n-Butyl acrylate and 2-ethylhexyl acrylate are preferred acrylate monomers. Preferably, at least 80, more preferably at least 90 weight percent of the polymer particles comprise structural units of styrene and an acrylate monomer.

The z-average particle size of the polymer particles as measured using dynamic light scattering is in the range of from 50 nm or from 80 nm, to 500 nm or to 300 nm or to 200 nm.

The resulting dispersion contains residual monomer, which is contacted with a reductant such as isoascorbic acid or 2-hydroxy-2-sulfinatoacetic acid disodium salt, and a t-C₄-C₁₀-alkyl hydroperoxide to chase residual monomer. Preferably, the t-C₄-C₁₀-alkyl hydroperoxide is t-butyl hydroperoxide (t-BHP) or t-amyl hydroperoxide (t-AHP) or a combination thereof.

The mole-to-mole ratio of the t-C₄C₁₀ alkyl hydroperoxide to the reductant is preferably in the range of from 1:1 or from 3:1 or from 3.5:1 or from 4.5:1 or from 5.5:1 or from 6.5:1 or from 7.0:1, to 50:1 or to 30:1 or to 20:1 or to 15:1 or to 10:1. The efficiency of this redox system can be controlled by a number of factors including the optional addition, in or after step a) of: a) a catalytic amount of a redox reaction catalyzing metal salt, for example, a salt of iron (II) such as FeSO₄, copper, manganese, vanadium, silver, platinum, nickel, chromium, palladium, or cobalt, or combinations thereof; b) addition of a chelating agent for the metal salt; c) adjustment of temperature; and d) adjustment of pH.

Accordingly, the t-C₄-C₁₀-alkyl hydroperoxide and reductant, optionally in the presence of a catalyzing metal salt and a chelating agent, may be contacted with the aqueous dispersion of polymer particles in a single stage or in multiple stages using the same or different mole-to-mole ratios in each stage, provided the mole-to-mole ratio of the total amount of t-C₄-C₁₀-alkyl hydroperoxide added to the total amount of reductant added over multiple steps is in the prescribed range. For example, the t-C₄-C₁₀-alkyl hydroperoxide and reductant can be added at a mole-to-mole ratio of the t-C₄-C₁₀-alkyl hydroperoxide to reductant in the range of from 1:1 to 3:1 followed by post-addition of t-C₄-C₁₀-alkyl hydroperoxide to increase the mole-to-mole ratio of 1-C₄-C₁₀-alkyl hydroperoxide to reductant to a range of greater than 3:1 to 50:1.

The resultant aqueous dispersion of polymer particles is preferably neutralized in, or after step a), more preferably in, or after step b) to a pH in the range of from 7.5 or from 8.0 or from 8.5 or from 8.8, to 10.0 or to 9.5 or to 9.2.

The resultant composition comprises from 250 ppm or from 300 ppm or from 350 ppm or from 450 ppm or from 550 ppm or from 700 ppm to 5000 ppm or to 2500 ppm or to 1500 ppm of t-C₄-C₁₀-alkyl hydroperoxide and preferably less than 1000 ppm, more preferably less than 500 ppm of residual monomer. The concentration of the t-C₄-C₁₀-alkyl hydroperoxide in the composition is determined using NMR spectroscopy as detailed in the experimental section.

In another aspect, the present invention is a method comprising the steps of:
a) contacting styrene and an ethylenically unsaturated monomer under emulsion polymerization conditions to form an aqueous dispersion of styrenic copolymer particles and residual monomers; and
b) contacting the dispersion of the styrenic copolymer particles with a reductant and a t-C₄-C₁₀-alkyl hydroperoxide to reduce the concentration of residual monomers in the aqueous dispersion to less than 1000 ppm of residual monomers; wherein the mole-to-mole ratio of the t-C₄-C₁₀-alkyl hydroperoxide to reductant is in the range of from 3:1 to 50:1.

The composition of the present invention has been found to be resistant to the growth of mold, bacteria, and yeast under heat age conditions.

### EXAMPLES

NMR Spectroscopic Determination of t-AHP or t-BHP in Serum Phase

A 10-mL polycarbonate tube was charged with 3.0 mL of a latex sample, 3.0 mL of Milli-Q water, and centrifuged at 100,000 rpm for 15 min. The resulting clear supernatant was decanted and transferred into a 5-mm NMR tube. A flame-sealed capillary tube filled with an external standard (5.00 wt % d₄-sodium trimethylsilylpropionate in D₂O) was added to the NMR tube. Careful attention was paid to proper alignment of the external standard within the NMR tube. NMR spectra were obtained using the Bruker AVANCE III 600 spectrometer equipped with a 5-mm BroadBand CryoProbe. Each sample was tuned and shimmed individually but pulse widths and receiver gain were held constant for a sample series. Concentration of free t-amyl hydroperoxide was measured by using the zg pulse sequence with the following parameters: acquisition time (aq)=2.5 s, recycle delay (d1)=30 s, number of transients (ns)=1024, receiver gain (rg)=32, and pulsewidth (p1)=11 ms. All other parameters (time domain size, sweep width, dwell time, pre-scan delay, and carrier frequency) were left at the default values. Concentration of free hydroperoxide was calculated by comparing the integrations of peaks resonating around 1.2 ppm and the peak for the external standard at 0.0 ppm. Spectra were referenced to the external standard at 0.0 ppm on the trimethylsilyl chemical shift scale. The purity of the resonances ascribed to hydroperoxides were unambiguously confirmed with a ¹H-¹³C heteronuclear multiple bond coherence (HMBC) experiment using the hmbcgplpndqf pulse sequence. SSS oligomer content was calculated by comparing the normalized integrations of peaks resonating around 7 ppm and the peak for the external standard at 0.0 ppm. Integral normalization was estimated by using a diffusion-ordered spectroscopy (DOSY) experiment using the ledbpgp2s pulse sequence to determine the weighted average mass of the SSS oligomers.

### Preparation of Samples for Microbial Resistance

Samples were tested for microbial resistance “as-is” (not heat-aged) as well as after being subjected to 50° C. for four-weeks (heat-aged). A 10-g aliquot was taken from each sample and inoculated three times at 7-d intervals with 10⁶-10⁷ colony forming units per milliliter of sample (CFU/mL) of a standard pool of bacteria, yeasts, and molds obtained from American Type Culture Collection (ATCC) that are common contaminants in coatings. Once inoculated, the samples were stored in 25° C. incubators. Test samples were monitored for microbial contamination by agar plating using a standard streak plate method. Samples were plated 1 d and 7 d after each microbial challenge onto trypticase soy agar (TSA) and potato dextrose agar (PDA) plates. All agar plates were checked daily up to 7 d after plating to determine the number of microorganisms surviving in the test samples. Between checks, the agar plates were stored in incubators at 30° C. for TSA plates and at 25° C. for PDA plates. The extent of microbial contamination was established by counting the colonies, where the rating score was determined from the number of microbial colonies observed on the agar plates. Reported results come from day 7 readings, and are summarized for both the “as-is” and heat-aged samples. Results are described by the rating score for each type of microorganism: B=bacteria, Y=yeast, and M=mold. For example, a 3B describes a plate with 3 rating score for bacteria, or a Tr Y(1) describes a plate with trace yeast (1 colony on plate). Table 1 illustrates the rating system used to estimate the level of microbial contamination on streak plates. Colonies refers to the number of colonies on the plate.

TABLE 1
Rating system for estimating microbial contamination

| Colonies | Rating Score | Contamination | Result |
|---|---|---|---|
| None | 0 | None | Pass |
| 1-9 | Tr | Trace | Pass |
| 10 to 99 | 1 | Very Light | Fail |
| 100 to ~1000 | 2 | Light | Fail |
| ~1000 to 10,000 | 3 | Moderate | Fail |
| >10,000 | 4 | Heavy | Fail |

In Table 1, “Pass” means fewer than ten colonies were detected on plates on the specified day (Day 1 (D1) or Day 7 (D7)) after inoculation. “Fail means that ten or more distinct colonies were detected on plates on the specified day after inoculation.

### Comparative Example 1—Preparation of a Styrene-Acrylic Latex

A monomer emulsion was prepared by mixing deionized water (445 g), sodium lauryl sulfate (42.25 g, 28% active), Disponil FES-993 surfactant (12.09 g, 30% active), butyl acrylate (1143.54 g), styrene (782.73 g), vinyltrimethoxysilane (5.92 g), sodium 4-vinylbenzene sulfonate (6.57 g, 90% active) and acrylic acid (33.52 g).

To a 5-L, four necked round bottom flask equipped with a paddle stirrer, a thermometer, N₂ inlet, and a reflux condenser was added deionized water (770 g) and sodium lauryl sulfate (1.5 g, 28% active). The contents of the flask were heated to 87° C. under N₂ and stirring was initiated.

A portion of the monomer emulsion (86 g) was then added, quickly followed by an aqueous solution of sodium persulfate (2.35 g) dissolved in deionized water (47 g) followed by a rinse of deionized water (5 g). After stirring for 5 min, the remainder of the monomer emulsion and a solution containing sodium persulfate (7.05 g) and sodium hydroxide (3 g, 50% active) dissolved in deionized water (197 g) were each added separately to the flask over a total period of 150 min. The contents of the flask were maintained at a temperature of 87° C. during the addition of monomer emulsion. When all additions were complete, the vessel containing the monomer emulsion was rinsed with deionized water (25 g), which was then added to the flask.

The contents of the flask were cooled to 75° C. and an aqueous solution of FeSO₄ (21.0 g, 0.1% solids), an aqueous solution of the tetrasodium salt of EDTA (1.2 g, 1% solids) were added to the kettle. A first catalyst/activator pair of t-amyl hydroperoxide (t-AHP, 1 g, 85% active) dispersed in 15 g of deionized water and isoascorbic acid (0.5 g) dissolved in 15 g of deionized water was then added to the flask to reduce residual monomer. The contents of the flask were held at 75° C. for 10 min following the addition. After the 10 min hold, a second catalyst/activator pair of t-AHP (2 g, 1×, 85% active) and Disponil FES-993 surfactant (1.7 g, 30% active) dispersed in 30 g of deionized water and isoascorbic acid (1.9 g) dissolved in 35 g of deionized water were added linearly and separately to the flask over a period of 20 minutes. The contents of the flask were cooled to 55° C. during the addition of the second catalyst/activator pair. The pH was adjusted to 8.9.

### Example 1—Preparation of a Styrene-Acrylic Latex with Excess t-AHP

The method of Comparative Example 1 was repeated except that the amount of t-AHP added in the second catalyst pair was 5 g (2×) instead of 2 g. The pH was adjusted to 9.0.

### Example 2—Preparation of a Styrene-Acrylic Latex with Excess t-AHP

The method of Comparative Example 1 was repeated except that the amount of t-AHP added in the second catalyst pair was 8 g (3×) instead of 2 g. The pH was adjusted to 9.0.

Table 2 illustrates the relative concentrations of t-AHP added with respect to Comparative Example 1, as well as the concentrations of t-AHP and t-amyl hydroperoxide (t-AmOH) measured in the final neutralized dispersion.

TABLE 2
Relative Concentrations of t-AHP

| | | t-AHP | t-AmOH |
|---|---|---|---|
| | t-AHP added | measured (ppm) | measured (ppm) |
| Comp. Ex. 1 | 1x | 105 | 119 |
| Ex. 1 | 2x | 345 | 140 |
| Ex. 2 | 3x | 542 | 144 |

Table 3 illustrates the heat-age challenge test results for the samples.

TABLE 3
Heat-Age Challenge Test Results

| | C1 | C2 | C3 |
|---|---|---|---|
| Comp. Ex. 1 | Fail | Fail | Fail |
| Ex. 1 | Pass | Pass | Fail |
| Ex. 2 | Pass | Pass | Pass |

The data demonstrate that increased levels of t-AHP are effective in preserving acrylic-based latexes against microbial growth.

1. A composition comprising a) an aqueous dispersion of styrenic copolymer particles having a z-average particle size in the range of from 50 to 500 nm; and b) a C₄-C₁₀-alkyl hydroperoxide having a concentration in the range of from 250 ppm to 5000 ppm, based on the weight of the composition.

2. The composition of claim 1 wherein the concentration of the C₄-C₁₀-alkyl hydroperoxide is in range of from 300 ppm to 2500 ppm, and the C₄-C₁₀-alkyl hydroperoxide is t-butyl hydroperoxide or t-amyl hydroperoxide or a combination thereof; wherein the composition has a pH in the range of from 7.5 to 10.0.

3. The composition of claim 1 wherein the concentration of the C₄-C₁₀-alkyl hydroperoxide is in range of from 450 ppm to 2500 ppm, and the C₄-C₁₀-alkyl hydroperoxide is t-amyl hydroperoxide; wherein the composition has a pH in the range of from 8.0 to 9.5.

4. The composition of claim 3 wherein the concentration of t-amyl hydroperoxide is in the range of from 550 ppm to 1500 ppm.

5. The composition of claim 4 wherein the C₄-C₁₀-alkyl hydroperoxide is t-butyl hydroperoxide or t-amyl hydroperoxide or a combination thereof.

6. The composition of claim 5 wherein the C₄-C₁₀-alkyl hydroperoxide is t-amyl hydroperoxide.

7. The composition of claim 1 wherein the styrenic copolymer particles comprise structural units of styrene and structural units of an acrylate monomer; wherein the weight-to-weight ratio of the structural units of the acrylate monomer to the structural units of styrene is in the range of from 60:40 to 30:70.

8. The composition of claim 7 wherein the polymer particles further comprise from 0.1 to 10 weight percent structural units of sodium 4-vinylbenzene sulfonate; and wherein at least 80 weight percent of the polymer particles comprise styrene and an acrylate monomer.

9. The composition of claim 8 wherein the acrylate monomer is n-butyl acrylate or 2-ethylhexyl acrylate; and wherein the composition has pH in the range of from 8.0 to 9.5.
